(19) United States
(12) Patent Application Publication
(10) Pub. No.: US 2014/0103015 A1
(43) Pub. Date: Apr. 17, 2014

(54) INSTALLATION FOR FABRICATING A PART BY SELECTIVELY MELTING POWDER

(71) Applicant: SNECMA, Paris (FR)

(72) Inventors: Jean-Francois Castagne, Bourg La Reine (FR); Damien Hebuterne, Breuillet (FR); Thomas Vilaro, Paris (FR)

(73) Assignee: SNECMA, Paris (FR)

(21) Appl. No.: 14/118,623

(22) PCT Filed: May 15, 2012
(86) PCT No.: PCT/FR12/51076

§ 371 Date: Nov. 19, 2013

(30) Foreign Application Priority Data
May 20, 2011 (FR) 11 54415

(51) Int. Cl. B23K 15/00; B23K 26/34

(52) U.S. Cl. CPC B23K 15/0086; B23K 26/345
USPC 219/76.1; 219/121.16; 219/121.65

(57) ABSTRACT

An installation for fabricating a part by selectively melting powder, the installation including a mechanism producing a beam, for example a laser beam or an electron beam, and a mechanism moving a point of impact of the beam over a layer of powder. The installation further includes a collector element for collecting projections of molten powder produced during local melting of the powder by the beam, the collector element including an opening for passing the beam, and a mechanism configured to move the collector element jointly with the beam over the layer of powder.

The present invention relates to an installation for fabricating a part by selectively melting powder with the help of a laser beam or of an electron beam, such a method also being known as direct metal laser sintering or electron beam melting.

A method is known in the art that consists in fabricating a part by melting successive layers of powder by means of a laser beam or of an electron beam controlled by a data processing system having recorded therein the three-dimensional coordinates of points of successive layers to be made. In practice, a first layer of powder is placed in a vessel having a bottom constituted by a plate that is movable in translation, the powder being placed therein with the help of a scraper or a roller. The layer deposited on the plate has a top surface onto which the laser beam or the electron beam is directed and over which it is moved. The energy delivered by the beam causes the powder to melt locally, and on solidifying it forms a first layer of the metal part.

After this first layer has been formed, the plate is lowered through a distance corresponding to the thickness of one layer, and then a second layer of powder is brought by the scraper onto the preceding layer. A second layer of the metal part is then made in the same manner as before with the help of the beam.

These operations are repeated until the part has been fabricated in full.

This method may be used in particular for making parts having thin wall thicknesses or parts that present shapes that are complex and difficult to make by casting or by conventional machining.

While the powder is being melted, drops of molten metal are projected out from the liquid bath, i.e. out from the molten zone that has not yet solidified, and they become deposited on the non-melted powder or on the metal that has already melted. On solidifying these drops form solid particles of grain size greater than the grain size of the powder.

Because of their dimensions (e.g. of the order of 300 microns (μm)), these particles cannot be melted by the beam. Consequently, all of the particles that fall onto zones that are to be scanned subsequently by the beam will end up being present in the core of the finished part, without any cohesion with the material surrounding them. They constitute defects that weaken the part and that degrade its mechanical properties.

The defects due to these projections can be limited only by lengthy and expensive diffusion heat treatment.

A particular object of the invention is to provide a solution to this problem that is simple, effective, and inexpensive.

To this end, the invention provides an installation for fabricating a part by selectively melting powder, the installation comprising means for producing a beam, e.g. a laser beam or an electron beam, and means for moving the point of impact of the beam over a layer of powder, the installation being characterized in that it includes a collector element for collecting projections of molten powder produced during local melting of the powder by the beam, which element is suitable for collecting the projections of molten powder that impact thereagainst or drop thereon, in such a manner that the projections attach thereto on solidifying, the collector element having an opening for passing the beam, and means designed to move said collector element jointly with the beam over the layer of powder.

In this way, throughout the melting of the powder, the projections of molten powder become attached to the collector element on solidifying, without running the risk of dropping onto the surface of the part being made.

Preferably, the collector element is mounted on a frame, the means for moving said collector element comprising means for moving the frame in two perpendicular directions.

According to a characteristic of the invention, the collector element is placed inside the frame and the frame has a peripheral edge connected to the collector element via connection arms.

In an embodiment, the collector element is a plate, e.g. in the form of a disk, presenting an opening for passing the beam and the projections of molten powder, this opening having a section greater than the section of the beam.

Said opening is preferably upwardly flared, and for example it is frustoconical.

This ensures that the drops or particles that have been projected upwards and that follow a trajectory that is generally parabolic in shape do not touch the inside wall of the opening and do not collect thereon. The drops or projections of molten powder thus pass right through the opening and drop onto the top face of the collector plate where they solidify.

In addition, the top face of the plate may include inner and outer peripheral edges that project upwards.

This characteristic makes it possible to avoid particles that have not become attached to the top face of the plate from being able to drop onto the bed of powder. The inner peripheral edge is defined by the edge of the opening.

By way of example, these projecting edges are formed by a top face presenting an annular concave shape around the opening.

In another embodiment, the collector element is tubular, the projections of molten powder being for collection on the inside wall of the collector element.

The material of the collector element should then be determined as a function of the nature of the particles so as to guarantee that the projections of molten powder become attached to the inside surface of the collector element.

The height of the collector element is preferably greater than 5 millimeters (mm) and its hollow zone has a tapering section.

The invention also provides a method of fabricating a part by selectively melting powder with the help of an installation of the above-specified type, the method consisting in building up a part layer by layer by jointly moving the beam and the collector element in such a manner that at least some of the projections formed while the powder is being melted by the beam are collected by the collector element by solidification of the projections of molten powder that has impacted against or dropped onto the collector element.

The invention can be better understood and other details, characteristics, and advantages of the invention appear on reading the following description made by way of non-limiting example and with reference to the accompanying drawings, in which:

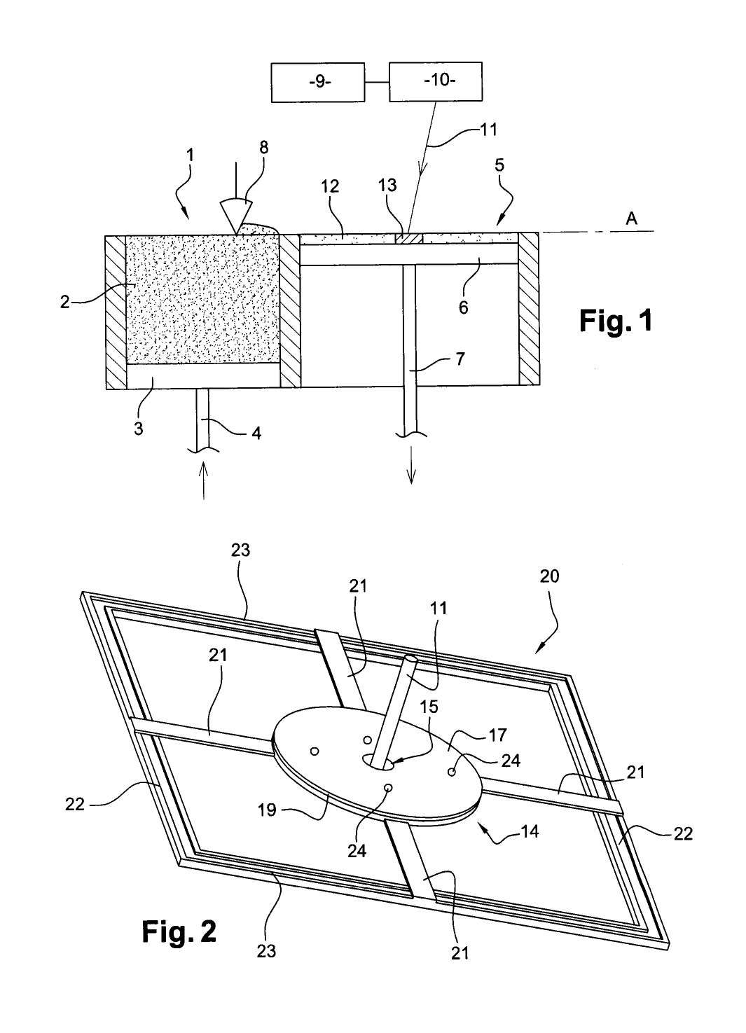

FIG. 1 is a diagrammatic view of a prior art installation for fabricating a metal part by selectively melting a powder;

FIG. 2 is a perspective view of a collector element and of the frame on which it is mounted in a first embodiment of the invention;

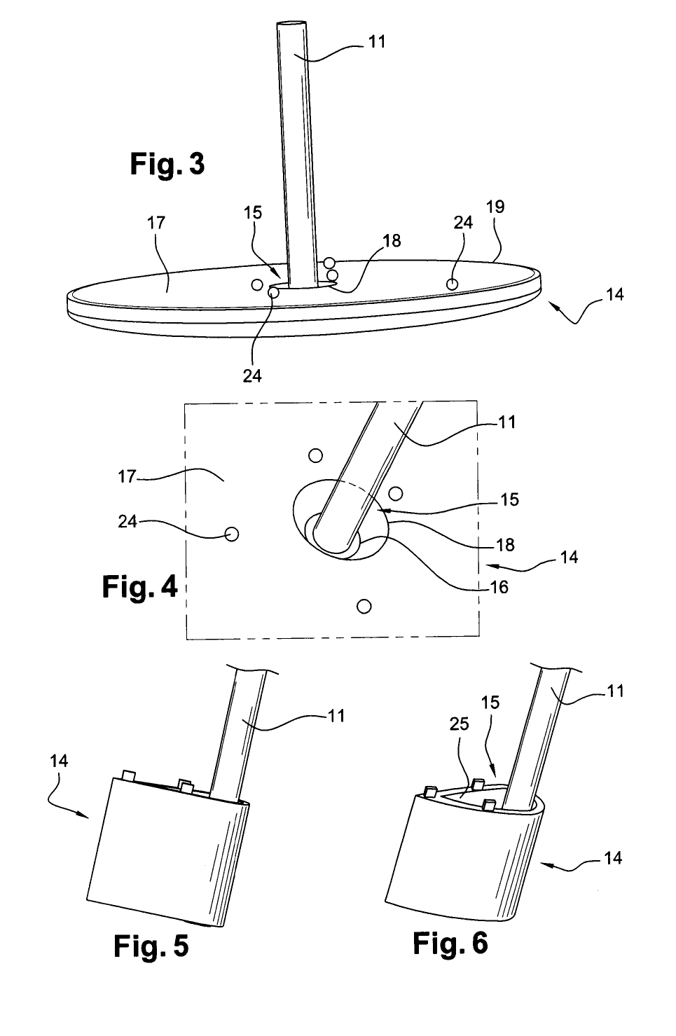

FIG. 3 is a perspective view of the FIG. 2 collector element;

FIG. 4 is an enlarged view of a portion of the collector element of FIGS. 2 and 3; and

FIGS. 5 and 6 are perspective views of a collector element in a second embodiment of the invention.

An installation for fabricating a metal part by selectively melting a powder is shown in FIG. 1. It comprises a tank 1 containing a metal powder 2 and having a bottom 3 that is movable in translation under drive from a rod 4 and an actuator, with an adjacent vessel 5 having its bottom constituted by a movable plate 6, likewise movable in translation by a rod 7 of an actuator.

The installation has a scraper 8 or a roller for bringing powder from the tank 1 towards the vessel 5 by moving in a horizontal plane A, and it also has means 9 for generating a laser beam or an electron beam, said means being coupled to a device 10 for pointing and moving the beam 11.

The steps of fabricating a metal part with the help of this installation are as follows.

Firstly, the bottom 3 of the tank 1 is moved upwards so that a certain quantity of powder 2 is situated above the horizontal plane A. The scraper 8 is then moved from left to right so as to scrape said layer of powder 2 from the top of the tank 1 and bring it into the vessel 5. The quantity of powder 2 and the position of the plate 6 are determined so as to form a layer 12 of powder having a selected and constant thickness.

A laser beam or a beam of electrons 11 then scans a determined zone of the layer 12 formed in the vessel 5 in such a manner as to melt the powder 2 locally in the scanned zone. The molten zones solidify, thereby forming a first layer 13 of the part to be fabricated, this layer 13 having thickness in the range 10 μm to 100 μm, for example.

The plate 6 is then lowered by the thickness of the layer that has been made and then a new layer of powder 2 is brought onto the first layer of powder in the same manner as before. By controlled movement of the beam 11, a second layer of the metal part is formed on the first layer 13.

These operations are repeated until the part has been made completely.

When the part is built up layer by layer by selectively melting the powder 2 with the help of a laser beam, the powder 2 presents mean grain size lying in the range 10 μm to 40 μm.

When the part is built up layer by layer by selectively melting the powder 2 with the help of an electron beam, the powder 2 presents mean grain size lying in the range 50 μm to 100 μm.

As explained above, drops of molten metal may be projected out from the liquid bath during local melting of the powder with the help of the beam, and they may become deposited on the part that is being fabricated. On solidifying these drops form particles of large size that cannot be melted subsequently. Parts made in that way can then include core defects, thereby reducing their strength.

In order to avoid that, the invention proposes collecting some or all of these projections or these particles with the help of a collector element.

A first embodiment of the invention is shown in FIGS. 2 to 4, in which the collector element is a disk-shaped dish 14 made of metal or ceramic. The collector element 14 has a central opening 15 for passing the beam 15 and also projections of molten powder, this opening having a section that is greater than the section of the beam. The opening is frustoconical and flares upwards. The diameter of the opening at its bottom end 16 may for example be about 1 mm, whereas the diameter of the beam is about 50 μm to 100 μm.

The top surface 17 of the collector element 14 presents an annular concave surface surrounding the opening. The radially inner and outer peripheral edges 18 and 19 are thus raised relative to the middle zone.

The collector element 14 is mounted on a frame 20 having a peripheral edge of rectangular shape, and connected to the collector element via four connection arms 21. The collector element 14 is preferably centered relative to the frame 20. The frame thus has two side edges 22 and two longitudinal edges 23 perpendicular to the side edges, with an arm connecting each edge 22, 23 to the radially outer edge 19 of the collector element 14.

The frame 20 is moved over the layer 12 of the powder 2 by means of its side and longitudinal edges 22 and 23 in two mutually perpendicular directions with the help of appropriate means. Such movement means are well known to the person skilled in the art and are not described in detail herein. The frame 20, and thus the collector element 14, are moved jointly with the beam 11, synchronously therewith, so that regardless of the position of the beam 11, it always passes through the opening 15 in the collector element 14.

The part is built up layer by layer by moving the beam 11 and the collector element 14 jointly. The beam 11 passes through the opening 15 and reaches the layer 12 of powder 2 so as to melt it locally. The impact of the beam 11 in the liquid bath acts as in the prior art and generates projected drops or particles 24 that follow trajectories that are substantially parabolic. These projections pass through the opening 15 either in the annular zone between the edge of the opening 15 and the beam 11, or else through the beam 11, and then they drop back onto the concave top surface 17 of the collector element 14. The distance between the liquid bath and the top end 18 of the opening 15 is about 1 mm.

The dimensions of this collector element 14 are determined as a function of parameters of the installation, such as in particular the power of the beam 11, so as to guarantee that the drops are not projected beyond the radially outer edge 19 of the top surface 17. The diameter of the collector element 14 may for example be about 50 mm to 100 mm.

The concave shape of the top surface 17 prevents the projections or particles that fall onto the top surface 17 from rolling beyond the radially inner and outer edges 18 and 19 of the surface 17, and then dropping back onto the layer 12 of powder 2.

This concave shape also serves to make it easier to recover projections that have already solidified.

In an embodiment that is not shown, the collector element is merely a plate having an opening, preferably a narrow opening for allowing the laser beam to pass. In this embodiment, the projections impact against and solidify on the bottom face of the plate.

FIG. 5 or 6 show another embodiment of the invention, in which the collector element 14 is tubular and has a hollow zone forming the opening 15 for passing the beam 11, the particles 24 being collected on the inside wall 25 of the hollow zone. The height of the tubular collector element 14 is about 20 mm.

The section of the hollow zone may be circular or tapering, as shown in FIG. 6. The tapered section corresponds to the section of the liquid bath formed by melting the powder 2 with the help of the beam 11. This bath has a substantially circular upstream portion corresponding to the zone melted at an instant t by the beam 11, and a tapering downstream zone corresponding to the previously-melted zone that is solidifying.

This collector element 14 may be mounted on a frame similar to that described above so as to be moved together with the beam.

In each of these embodiments, the invention proposes an installation in which the drops or particles 24 projected from the liquid bath throughout the melting of the powder 2 impact against or drop onto the collector element 14 in such a manner as to be attached thereto on solidifying, without running any risk of dropping back onto the part that is being fabricated.

In certain preferred embodiments, the invention does not have any suction means and/or air blower means.

1-10. (canceled)

11. An installation for fabricating a part by selectively melting powder, the installation comprising:
means for producing a beam, or producing a laser beam or an electron beam;
means for moving a point of impact of the beam over a layer of powder;
a collector element for collecting projections of molten powder produced during local melting of the powder by the beam, which collector element is configured to collect the projections of molten powder that impact thereagainst or drop thereon, such that the projections attach thereto on solidifying, the collector element including an opening for passing the beam; and
means for moving the collector element jointly with the beam over the layer of powder.

12. An installation according to claim 11, wherein the collector element is mounted on a frame, the means for moving the collector element comprising means for moving the frame in two perpendicular directions.

13. An installation according to claim 12, wherein the collector element is placed inside the frame and the frame includes a peripheral edge connected to the collector element via connection arms.

14. An installation according to claim 11, wherein the collector element is a plate, or is in a form of a disk, presenting an opening for passing the beam and the particles, the opening having a section greater than a section of the beam.

15. An installation according to claim 14, wherein the opening flares upwards, or is frustoconical.

16. An installation according to claim 14, wherein the plate includes inner and outer peripheral edges projecting upwards.

17. An installation according to claim 11, wherein the collector element is tubular, the projections being for collection on an inside wall of the collector element.

18. An installation according to claim 17, wherein a height of the collector element is greater than 5 mm.

19. An installation according to claim 17, wherein the collector element includes a hollow zone of tapering section.

20. A method of fabricating a part by selectively melting powder with an installation according to claim 11, the method comprising:
building up a part layer by layer by jointly moving the beam and the collector element such that at least some of the projections formed while the powder is being melted by the beam are collected by the collector element by solidification of the projections of molten powder that has impacted against or dropped onto the collector element.
